(19) United States
(12) Patent Application Publication
(10) Pub. No.: US 2008/0190018 A1
(43) Pub. Date: Aug. 14, 2008

(54) FLEXIBLE VASE

(75) Inventor: Anne CAO, Courtice (CA)

Correspondence Address: DIMOCK STRATTON LLP, 20 QUEEN STREET WEST SUITE 3202, BOX 102, TORONTO, ON, M5H 3R3, omitted

(73) Assignee: Outside the Vase. Inc., Courtice (CA)

(21) Appl. No.: 11/673,862

(22) Filed: Feb. 12, 2007

(51) Int. Cl. A01G 5/04

(52) U.S. Cl. 47/41.12; 47/41.01

(57) ABSTRACT

A flexible vase for transporting and displaying cut flowers comprising a flexible walled waterproof container that is capable of standing upright when partially filled with water. A block of floral foam sized to fit into the container and fill a bottom portion of the container secures the bases of the flower stems. A tie for cinching the walls of the container provides a mouth of the container of reduced effective size from the opening of the container. The container being capable of supporting the stems of the cut flowers.

### FIELD OF THE INVENTION

The present invention relates to a container for floral arrangements, and more particularly to a flexible vase for supporting and transporting floral arrangements.

### BACKGROUND OF THE INVENTION

Cut flowers are typically transported from a floral shop by placing the ends of the flower stems in a water reservoir, such as floral foam or a floral water tube, and wrapping the flowers to protect them during transport. While an effective means of transport, the standard practice requires one to lie the flowers flat during transport leaving them vulnerable to damage and the reservoir prone to leaking water.

An additional problem faced in the floral industry is the desire to provide a customer with an arrangement of cut flowers secure for transport in a container that may also serve as a vase for display. Past solutions have focussed on wrapping some form of structural support with the standard 1 or 2 ply plastic wrap used in the floral industry. The purpose of the plastic wrap is to provide a water barrier around the lightweight structural support. A limitation with these solutions has been that the plastic wrap may be punctured and leak during transport. An additional limitation has been that the lightweight containers are prone to tipping when placed on an uneven or irregular surface, such as a vehicle seat, or subjected to tipping forces while being transported in a vehicle.

Accordingly there arises a need for container capable of transporting an arrangement of cut flowers that may also serve as a vase for display. There arises an additional need for a container that is robust and unlikely to leak during transport. There arises a further need for a container that remains stable and capable of supporting an arrangement of cut flowers when placed on an irregular surface, or transported in a vehicle.

### BRIEF DESCRIPTION OF THE DRAWINGS

In drawings which illustrate by way of example only a preferred embodiment of the invention,

FIG. 1 is an isometric illustration of a container.

FIG. 2a is an isometric illustration of the container partially filled with water.

FIG. 2b is a side view illustration of the container on an uneven surface.

FIG. 3 is a representative side view cut away illustration of a flexible vase.

FIG. 4 is a representative side view illustration of a flexible vase.

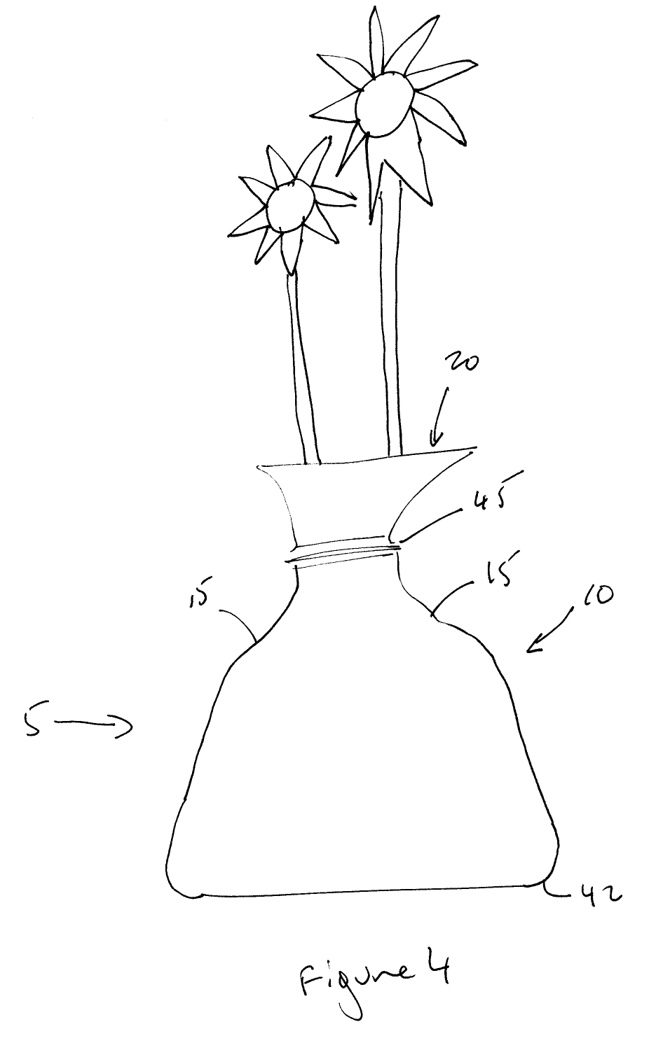

### DETAILED DESCRIPTION OF THE INVENTION

A flexible vase for transporting and displaying cut flowers may be constructed from a flexible walled waterproof container that is capable of standing upright when partially filled with water. Surprisingly, it has been found that a flexible walled water proof container that is capable of standing upright when partially filled with water is able to support the cut flowers without the requirement for any additional support structure or reinforcement to the container. Furthermore, such a flexible vase is capable of supporting fairly large flowers, such as sun flowers.

Since the walls of the container are flexible, the shape of the container is able to adapt to and accommodate minor irregularities on which the container is resting. As a result, the flexible vase is well-suited for transporting cut flowers in vehicles on irregular surfaces such as a car seat.

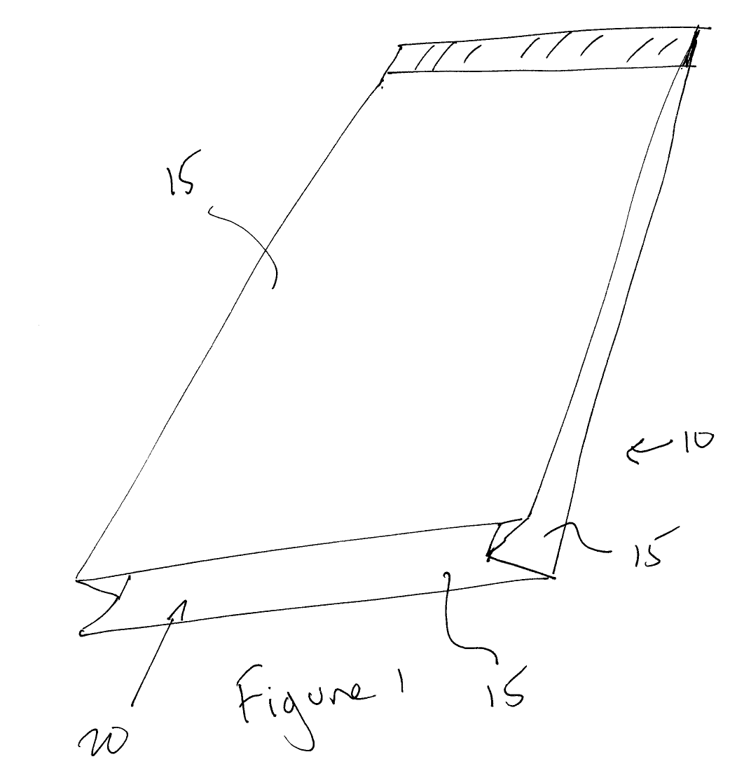

Referring to FIG. 1, a flexible vase may be constructed from a flexible walled water proof container 10. It has been found that a three layer poly-laminate gusseted bag provides an ideal flexible walled water proof container that is capable of standing upright when partially filled with water.

The three layer bags, also known as barrier bags, are typically used in the handling of dry goods such as roasted coffee. The bags are used for their durability and ability to keep the goods fresh.

Preferably, the three layer bags may be comprised of a middle metal layer with a polyester outer layer and a polyethylene outer layer. Generally the bags are provided with an aluminum middle layer, though other metals may also be used. Typically, the outer layers are bonded to the metal layer with an adhesive such as polyethylene or polyurethane, though other methods are known and used in the construction of poly-laminates. An advantage of a polyester outer layer is the ability to print colors or patterns on the outer to provide a more pleasing exterior to the container.

A typical barrier bag useful as a flexible walled water proof container 10 may be comprised of a three layer poly-laminate consisting of a polyester layer about 15 μm thick, an aluminum layer about 10 μm thick and a polyethylene layer of about 90 μm thick. While the layers may be bonded by a variety of methods, one known method comprises the use of a polyethylene adhesive to bond the polyester layer to the aluminum layer and a polyurethane adhesive to bond the aluminum layer to the polyethylene layer. One exemplar barrier bag demonstrated a polyethylene adhesive layer about 8 μm thick and a polyurethane adhesive layer <1 μm thick. It will be appreciated that these materials and layer thicknesses are by way of example only, and that other layer thicknesses and specific composition of layers may be suitable provided the resulting flexible walled water proof container is capable of standing upright when partially filled with water.

While other materials may be used, the three layer bag is preferred due to its properties of being durable, waterproof and sufficiently flexible yet capable of standing upright when partially filled with water.

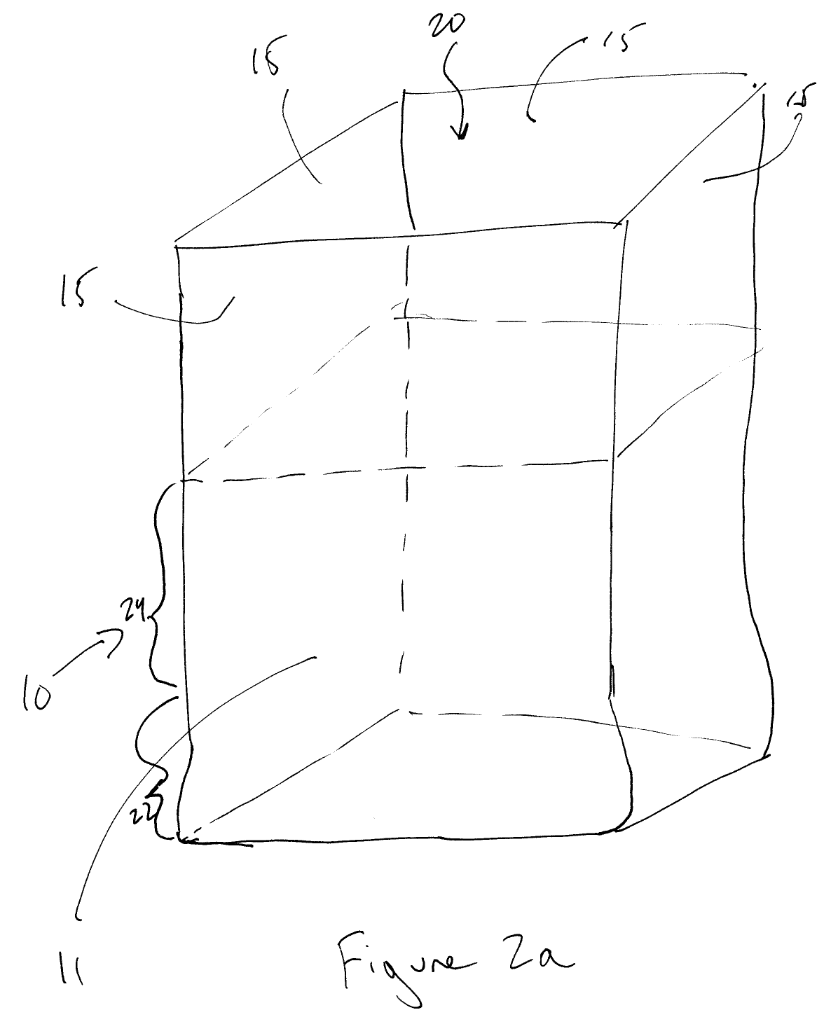

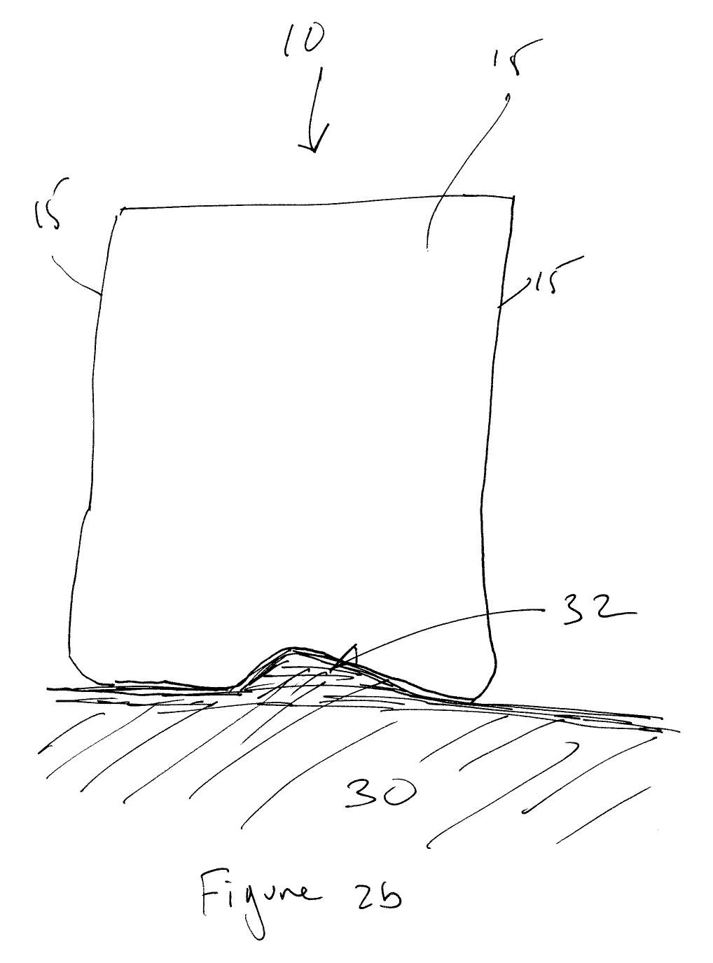

As illustrated in FIG. 1, the container 10 includes flexible walls 15 and an opening 20. FIG. 2a is an isometric illustration of the container 10 filled to the top of a middle portion 24 with water 11. The flexible walled waterproof container 10 is capable of standing unsupported when partially filled with water 11. As illustrated, the flexible walls 15 tend to bulge at the bottom of the container 10 under the weight of the water 11. As illustrated in the representative side view illustration of FIG. 2b, the flexible nature of the container 10 allows it to accommodate minor irregularities or unevenness 32 in the surface 30 on which it rests. The wall follows the irregularity, but the water 11 in the container 10 redistributes itself, thus maintaining the stability of the container 10. As a result, the container 10 is quite stable on uneven surfaces and maintains standing even when the surface at one side of the container 10 is at a different height from the other side.

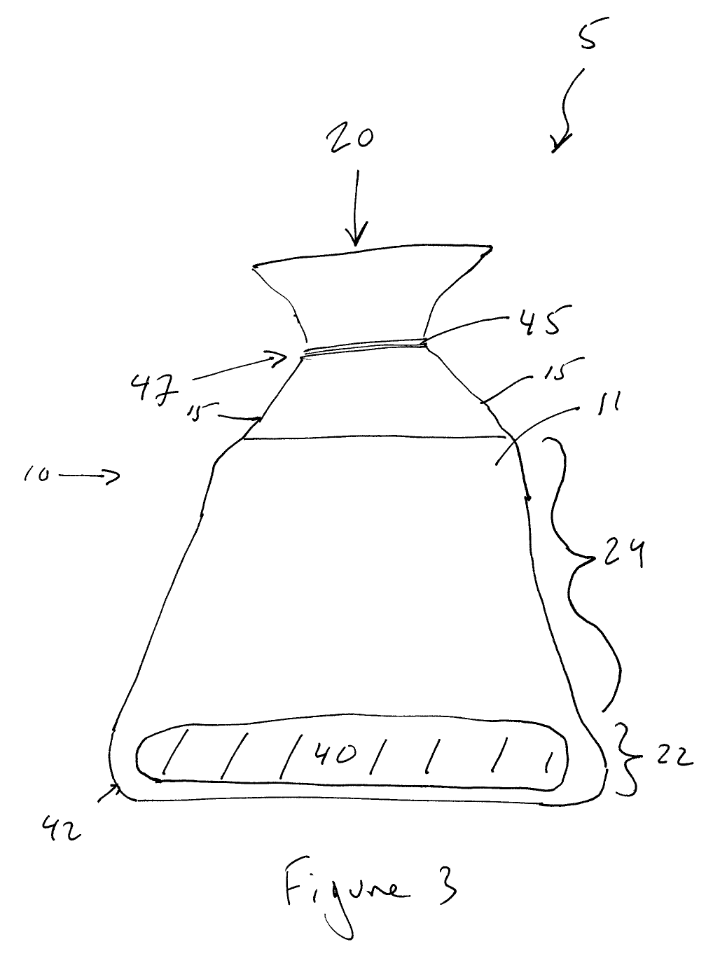

FIG. 3 is a representative side view cut away illustration of the flexible vase 5. The container 10 has side walls 15 and an opening 20. A means for securing the flower stems 40 is provided in a bottom portion 22 of the container 10. Preferably, the means for securing the flower stems 40 comprises a block of saturated floral foam 40 shaped to fit into the container 10. Preferably the foam 40 is roughly shaped to the internal dimensions of the container 10 at the bottom portion 22. While it is not strictly necessary for the foam 40 to be in contact with the walls 15, it is preferable if it is shaped to be in close proximity to the walls 15 to restrict its mobility within the container 10. The purpose of the foam 40 is to secure the base of the stems of cut flowers near the bottom of the container 10 and to assist in locating the stems near the center of the opening 20. The foam 40 assists in supporting the flowers, by securing the base of the stems in a relatively fixed location within the container 10. The weight of a flower tends to urge the base of the stem to one side of the container 10. When secured in the foam 40, the base of the stem is constrained by the walls 15 preventing the foam 40 from shifting.

As illustrated, a tie 45 may be used to cinch the container 10 just above a middle portion 24 of the container 10 to provide a mouth 47 of reduced size compared to the opening 20 of the container 10. While the container 10 is capable of standing on its own when partially filled with water 11, the tie 45 provides a flexible vase 5 of increased stability and improves the ability of the vase 5 to support the flower stems. Among other factors, the improved support results from the combination of the mouth 47 and the foam 40 maintaining flowers closer to the center of the container 10 than would be the case for a flower supported by a container 10 without a tie 45. The foam 40 secures the base of the flower stems and the mouth 47 locates a middle part of the flower stem near the center of the container 10. As a result, the flower may be maintained near the center of the container.

Preferably after cinching the tie 45, the container 10 may filled with water to just below the tie 45 near the top of the middle portion 24 of the container 10. The water 11 increases the stability of the container 10 and enables the container 10 to provide support for the flower stems. The water is also conveniently used to keep the foam 40 saturated for the flowers. As will be appreciated the water may comprise a floral solution as is commonly used for cut flowers.

The tie 45 also improves the stability by changing the shape of the container 10 and increasing the tension in the walls 15 under the weight of the water 11. The walls 15 tend to bulge outward where they contact with the water 11. The change in shape creates a vase 5 with a wider base 42 than mouth 47. Thus, the mouth 47 supports the flower stem at a position closer to the center of the container 10 than the location of the walls 15 at the base 42. The increased tension results in the mouth 47 providing a stable support for the flower stem above the foam 40. This support is provided by the combination of the tie 45 cinching the flexible walls 15 of the container 10 and providing a mouth 47 of reduced effective size from the opening 20. Attempts to shift the mouth 47 is resisted by tension in the walls 15 created by the water 11.

A preferred method for constructing a flexible vase 5 consists of placing a block of saturated floral foam 40 into the container 10. The foam 40 may be saturated with water or a floral solution as is known in the art of floral arranging. The stems of the flowers to be contained in the vase 5 may then be inserted into the foam 40. The tie 45 may then be cinched around the container 10 just above a middle portion 24 of the container 10 to provide a mouth 47 of sufficient sized to accommodate the stems. Water may then be added into the container to a level below the cinched tie 45 near the top of the middle portion 24 of the container 10.

Generally the top of the middle portion 24 may be described to be a sufficient height above the block 40 to give the vase 5 sufficient stability to support the flowers. Thus, the height should be sufficient given the dimensions of the container 10 to add sufficient weight to stabilise the vase 5 for a given floral grouping. The preferred height of the water 11 may vary for a particular container 10 and size of floral grouping. By way of example, it has been found that for a 6.5″×4″ container 10, a water height of about 4″ to 6″ above the bottom of the container 10 works well in conjunction with a tie 45 cinched about 8″ to 10″ above the bottom of the container 10. Typically the block of foam 40 may be sized to fill a bottom portion 22 1″ to 2″ high, though other heights are possible depending upon the size of the floral grouping and the size of available foam blocks.

It has been found that a flexible vase 5 thus formed provides a simple and effective means for transporting and displaying cut flowers. The vase 5 is quite stable on uneven or irregular surfaces and capable of supporting fairly substantial cut flowers, such as sunflowers. While prior methods in the floral industry required the use of a structural support or medium to support a floral grouping, the flexible vase 5 is able to support a group of cut flowers without any additional structural support.

The flexible vase 5 thus provides a cost effective and space saving solution to the problem of providing a container for transporting and displaying cut flowers. The flexible vase 5 further reduces the amount of floral foam 40 required to be used, and dispenses with the need for additional structural supports or other additions. As most florists have supplies of floral foam and ribbons on hand, the flexible vase 5 provides a simple and practical solution to the problems faced in transporting and displaying cut flowers.

Various embodiments of the present invention having been thus described in detail by way of example, it will be apparent to those skilled in the art that variations and modifications may be made without departing from the invention. The invention includes all such variations and modifications as fall within the scope of the appended claims.

I claim:

1. A flexible vase for transporting and displaying one or more cut flowers each having a stem, the vase comprising:
a flexible walled waterproof container capable of standing upright when partially filled with water, the container having a top opening;
means for securing the stems sized to fit into the container and fill a bottom portion of the container; and,
a tie for cinching the walls of the container to provide a mouth of the container of reduced effective size from the opening;
whereby when the one or more stems are secured in the means for securing the stems in the bottom portion of the container, and the tie is cinched around the container above a middle portion of the container above the bottom portion, and the container is filled with water to near the top of the middle portion of the container below the tie, the container is capable of supporting the stems of the one or more cut flowers.

2. The vase of claim 1 wherein the means for securing the stems comprises a block of saturated floral foam.

3. The vase of claim 1 wherein the container is comprised of a three layer laminated film.

4. The vase of claim 3 wherein the three layer laminated film is comprised of a middle layer between two outer layers.

5. The vase of claim 3 wherein the middle layer comprises a metal layer.

6. The vase of claim 4 wherein the metal layer is comprised of aluminum and the outer layers are comprised of plastic.

7. The vase of claim 4 wherein one outer layer is comprised of polyester and the other outer layer is comprised of polyethylene.

8. The vase of claim 6 wherein the outer layers are bonded to the middle layer with adhesive.

9. A kit for constructing a flexible vase for transporting and displaying one or more cut flowers each flower having a stem, the kit comprising:
a flexible walled waterproof container capable of standing upright and supporting the one or more cut flowers when partially filled with water, the container having a top opening; and,
a means for securing the stems in a bottom portion of the container;
whereby the vase is constructed by, placing the means for securing the stems into the bottom portion of the container, inserting ends of the stems into the means for securing the stems, cinching a tie around the container above a middle portion of the container above the bottom portion to provide a mouth of the container of reduced effective size from the opening;, and filling the container with water to near the top of the middle portion of the container below the tie.

10. The kit of claim 9 further comprising the tie.

11. The kit of claim 9 wherein the means for securing the stems comprises a block of floral foam shaped to fit into the container and fill the bottom portion of the container and whereby the vase is constructed by saturating the foam prior to inserting the ends of the stems.

12. The kit of claim 10 wherein the means for securing the stems comprises a block of floral foam shaped to fit into the container and fill the bottom portion of the container and whereby the vase is constructed by saturating the foam prior to inserting the ends of the stems.

13. The kit of claim 12 wherein the container is comprised of a three layer laminated film comprised of a middle metal layer between two plastic outer layers.

14. The kit of claim 13 wherein the metal layer is comprised of aluminum and one outer layer is comprised of polyester and the other outer layer is comprised of polyethylene.

15. A method of assembling a flexible vase for transporting and displaying one or more cut flowers each flower having a stem from a flexible walled waterproof container capable of standing upright when partially filled with water, the container having a top opening; the method comprising the following steps:
placing a means for securing the stems into the container;
securing the stems in the means for securing the stems;
cinching the walls of the container with a tie above a middle portion of the container to provide a mouth of the container of reduced effective size from the opening; and,
filling the container with water to a level near the top of the middle portion of the container below the tie.

16. The method of claim 15 wherein the means for securing the stems comprises a saturated block of floral foam shaped to fit into the container and fill a bottom portion of the container below the middle portion.

17. The method of claim 16 wherein the container is comprised of a three layer laminated film comprised of a middle aluminum layer between two plastic outer layers.

18. The method of claim 17 wherein the water comprises a floral solution.
